(19) United States
(12) Patent Application Publication
(10) Pub. No.: US 2011/0103807 A1
(43) Pub. Date: May 5, 2011

(54) REPLACEMENT SMART CARD WITH A MICROCONTROLLER

(76) Inventors: Joseph M. Cachia, Las Vegas, NV (US); Ken Segler, North Las Vegas, NV (US)

(21) Appl. No.: 12/870,509

(22) Filed: Aug. 27, 2010

Related U.S. Application Data
(60) Provisional application No. 61/280,049, filed on Oct. 30, 2009.
(60) Provisional application No. 61/339,594, filed on Mar. 8, 2010.

(51) Int. Cl. G03G 15/00; G06K 19/073

(52) U.S. Cl. 399/12; 235/492

(57) ABSTRACT

The invention is a replacement smart card that allows a printer to utilize a replacement printer cartridge. The replacement smart card has an integrated circuit and a microcontroller, wherein the microcontroller is programmed to intercept the request from the printer for the unique lot number data and to provide the appropriate unique lot number data to the printer in response to the request. The integrated circuit is programmed just like the original equipment manufacturer integrated circuit, and, with the exception of providing the unique lot number data to the printer, communicates with the printer just as the original equipment manufacturer integrated circuit would.

### CROSS-REFERENCE TO RELATED APPLICATIONS

Priority is claimed to U.S. Provisional Patent Application Ser. No. 61/280,049, filed on Oct. 30, 2009, titled “Replacement Printer Smartcard Utilizing a Microcontroller” by inventors Joseph M. Cachia and Ken Segler, the contents of which are expressly incorporated herein by this reference. Priority is also claimed to U.S. Provisional Patent Application No. 61/339,594, filed on Mar. 8, 2010, titled “Replacement Miniature Printer Cartridge Smartcard Utilizing a Microcontroller” by inventors Joseph M. Cachia and Ken Segler, the contents of which are expressly incorporated herein by this reference.

### BACKGROUND OF THE INVENTION

This invention relates to smart cards, and more specifically to a replacement smart card with a microcontroller that enables operation of a replacement imaging device cartridge.

Currently, most imaging devices, such as printers, copiers, faxes and multi-function machines, utilize user-replaceable cartridges that contain the printing media, usually toner, which is a dry ink, or liquid ink. Replacement cartridges replenish the toner or ink supply and allow the continuing ability to print high quality documents and images when the previous cartridge has been depleted. Historically, once the previous cartridge was removed from the printer, it was considered office trash and it was discarded. The cartridges were, generally, very durable and they were capable of continuing to provide excellent print quality. However, without an ink or toner supply, the cartridges were effectively useless. Some years ago, an industry of remanufacturers developed to collect these spent cartridges and remanufacture them to like-new condition.

Traditionally, the cartridges were disassembled, cleaned, damaged parts are replaced, and the toner or ink supply replenished. In recent years however, the original equipment manufacturers (“OEMs”) of the printers began including a “smart card” along with these cartridges. These smart cards are similar in construction to credit cards, but they utilize an imbedded Integrated Circuit (“IC”), typically with exposed contacts. The machines that require this type of replacement cartridge/smart card combination feature a slot in the machine, either internal or external, which specifically allows for the insertion of the smart card. The smart cards are programmed or written with data specific for the particular machine with which the cartridge is intended to be used. The size of the slot determines the specific physical size of the smartcard required.

After the replacement cartridge is installed in the machine, the display on the machine requests input from the user. This input is usually to: 1) confirm that a new cartridge is installed; and 2) request insertion of the smart card into the slot. The smart card is inserted into the slot, and the exposed contacts of the smart card connect to the corresponding contacts within the printer.

The purpose of the smart card is to allow the printing machine to verify that the cartridge installed is correct for the machine by reading the data on the smart card. If the data is correct, the machine allows printing using the recently installed imaging cartridge. If, however, the data is incorrect, the machine will not allow any function. Typically, the IC used on these smart cards uses encryption technology, as required for the smart card to be secure, and will not accept reads or writes without the proper password.

In single use/discard applications, once the machine or printer has verified the data on the smart card, a signal is sent from the machine to the smart card that locks the smart card from future use. The smart card is then removed from the slot, and discarded. When the toner is depleted, the machine will terminate the ability to print further with that cartridge, even after remanufacturing, unless a replacement smart card is also inserted into the proper slot. In the same manner, the machine will not work with merely a newly installed cartridge and no new smart card.

In continuous use applications, once the machine or printer has verified the data on the smart card, the machine initiates functions as required. However, the smart card in this application must remain in the machine slot for machine function to continue. Once the toner is depleted, the machine will then lock the smart card and terminate the ability to print further with that cartridge, even after remanufacturing, unless a replacement smart card is also inserted into the proper slot. In the same manner, the machine will not work with merely a newly installed cartridge and no new smart card.

Therefore, in order to provide a fully functioning remanufactured replacement cartridge, the remanufacturers must include a replacement smart card. These smart cards by design must emulate the physical fit and functionality of the OEM smart card to provide error-free usage. These replacement, or aftermarket, smart cards at one time were commercially available in blank format. Because these smart cards were commercially available, the specifications and programming instructions were also readily available.

As part of the smart card manufacturing process, the embedded IC in each smart card is lot coded with a unique identifier that is locked in the smart card IC and is not programmer/user changeable. Through analysis, suppliers of remanufactured printer cartridges and smart card combinations determined the proper passwords, or passcodes, to be programmed into the replacement smart card IC. These passwords were necessary to unlock the smart card for reading and writing when inserted into the machine.

Because all smart cards used to be commercially available, creating aftermarket versions that worked correctly was successfully accomplished. Recently, the resource capabilities of the OEMs enabled the OEMs to release numerous printer models and versions, which used smart cards, but the smart cards were programmed with different data. This forced the aftermarket replacement printer cartridge providers and remanufacturers to create a direct, one-for-one replacement product for each printer model type or version.

The same extensive OEM resource capabilities enabled the OEMs to develop smart card ICs with a specific, exclusive lot code series. As such, the smart cards used by the OEMs are part of a smart card series that are no longer standard or commercially available. Because the lot code is locked into the card IC and these lot codes are unique to the OEM, remanufacturers do not have direct access to these smart cards or lot code numbers. This is critical because the imaging machines require the card to have the correct lot code in order to proceed with any function, including printing.

Frequently, in continuous use applications of smart cards, the smart cards have been released by the OEMs that feature a smaller configuration than the original, credit card size cards. The machines that require this type of replacement cartridge/smartcard combination feature a slot specific for insertion of the smaller or miniature smart card. Similar to the larger size cards, the miniature smart cards are programmed or written with data specific for the particular machine the cartridge is intended. Other than being smaller and usually being continuous use application cards, the miniature smart cards are essentially identical to the larger smart cards, for example they can have contacts or be contactless and they emulate fit and function of the OEM smartcard to provide error-free usage.

Thus, what is needed is a smart card for a replacement cartridge that will be accepted by the printer and allow the user to utilize a remanufactured replacement cartridge.

### SUMMARY OF THE INVENTION

Various embodiments of the invention are directed towards overcoming the above deficiencies of the prior art by providing a replacement printer smart card that utilizes a microcontroller in conjunction with an IC to allow a user to utilize a replacement printer cartridge in a single use/discard application at start of printing with a freshly installed printing cartridge, or for applications that require the smartcard to remain in the machine for the duration of printing by the replacement printer cartridge.

One embodiment of the invention is a replacement smart card comprising: a smart card. The smart card is a printed circuit board that is comprised of a circuit. The circuit is comprised of an integrated circuit, a microcontroller, and supporting components. The smart card engages with a printer and the printer sends and receives one or more communications from the smart card. The circuit monitors one or more communications sent from the printer to the smart card. The printer sends a request for a unique lot number data to the smart card. The circuit senses when the printer sends the request for the unique lot number data and directs the request to the microcontroller. The microcontroller is programmed with the unique lot number data and returns the unique lot number data to the printer, which allows the printer to utilize a replacement printer cartridge.

Preferably, the microcontroller evaluates the communications from the printer and the microcontroller blocks the request for the unique lot number data from the printer from reaching the integrated circuit. Preferably the smart card further comprises one or more contacts when used in machines requiring direct contact. The smart card is inserted into a slot of the printer and the contacts engage with one or more printer contacts and allows the printer to send and receive one or more communications with the smart card. The circuit may further utilize a switch. The switch allows either the integrated circuit or the microcontroller to be in communication with the printer. The circuit further comprises one or more supporting components. The integrated circuit is preferably programmed with a set of data. The set of data is specific to a particular type of printer and is substantially similar to an original equipment manufacturer set of data except for the unique lot number data. The smart card functions just like an original equipment manufacturer smart card and accepts one or more communications from the printer except for the request for the unique lot number data.

Another embodiment of the invention is a replacement smart card comprising: a smart card. The smart card is a printed circuit board and is comprised of a circuit. The circuit is comprised of an integrated circuit, a microcontroller, a transfer printed circuit, one or more contacts, one or more supporting components, and a switch. The smart card is inserted into a slot of a printer and the contacts engage with one or more printer contacts and allows the printer to send and receive one or more communications with the smart card. The microcontroller evaluates the communications from the printer. The printer requests from the smart card a unique lot number data. The microcontroller activates the switch and the switch blocks the request for the unique lot number data from the printer from reaching the integrated circuit. The microcontroller is programmed with the unique lot number data and returns the unique lot number data to the printer when requested, which allows the printer to utilize a replacement printer cartridge. The integrated circuit is programmed with a set of data that is specific to a particular type of printer and is substantially similar to an original equipment manufacturer set of data except for the unique lot number data. The smart card functions just like an original equipment manufacturer smart card and accepts and responds to the communications from the printer except for the request for the unique lot number data.

Another embodiment of the invention is a miniature smart card. The miniature smart card is typically designed to be inserted into a slot in the machine and is left in the machine rather than being pulled out and discarded. Additionally, because this miniature smart card is inserted into a narrow slot with little room remaining for the handle, in one embodiment, the circuit components have been placed on opposite sides of the board in a way to clear the plastic slot in the machine. For applications that have more space available, the circuit components have been placed on a single side of the board.

Another embodiment of the invention is a method of enabling interoperation between a replacement printer cartridge and a printer comprising the steps of: providing a printer; providing a replacement printer cartridge; wherein the printer has a cavity that accepts the replacement printer cartridge; inserting the replacement printer cartridge into the printer cavity; providing a replacement smart card; wherein the printer has a slot for the replacement smart card; wherein the replacement smart card allows for utilization of the replacement printer cartridge by the printer; wherein the replacement smart card is a printed circuit board and is comprised of a circuit; wherein the circuit is comprised of an integrated circuit, a microcontroller, and one or more contacts; inserting the replacement smart card into the slot; wherein the contacts engage with one or more printer contacts; sending and receiving communications by the printer with the replacement smart card; evaluating by the microcontroller the communications from the printer; requesting by the printer a unique lot number data from the replacement smart card; wherein the microcontroller is programmed with the unique lot number data; returning the unique lot number data to the printer by the microcontroller, which allows the printer to utilize the replacement printer cartridge; said replacement smart card is designed as required to function in applications that require only an initial reading of the card to initiate printing, or applications that require the replacement smart card to remain inserted into the slot in the machine for the duration of the printing life of the replacement cartridge.

The method of enabling interoperation between a replacement printer cartridge and a printer preferably further includes the steps of: wherein the circuit further comprises a switch; activating the switch by the microcontroller; blocking by the switch the request for the unique lot number data from the printer from reaching the integrated circuit.

The method of enabling interoperation between a replacement printer cartridge and a printer preferably further includes: programming the integrated circuit with a set of data; wherein the set of data is specific to a particular type of printer and is identical to an original equipment manufacturer set of data except for the unique lot number data; wherein the replacement smart card functions just like an original equipment manufacturer replacement smart card and accepts and responds to the communications from the printer except for the request for the unique lot number data.

In this invention, the microcontroller is preferably used in conjunction with the original IC and both mounted on the smart card. The printed circuit board of the present invention has exposed contacts, which are similar to the original printer smart card, and allow the replacement smart card to be inserted into a printer to make connection. The exposed contacts in the original smart card are contacts for the embedded IC itself. In the present invention the exposed contacts are contacts with traces, or a transfer circuit that preferably leads to a circuit on the opposite end of the smart card.

In this invention, the microcontroller is preferably used in conjunction with the original IC and both of which are mounted on the smart card. The printed circuit board of the present invention may have no exposed contacts, instead communicating with the machine via a radio frequency (“RF”) signal as required for the particular type and style of the imaging machine. In the present invention the communication means of the receiver/transponder are imbedded within the smartcard, and connected with traces, or a transfer circuit that may lead to a circuit on the opposite end of the smart card. An object of the present invention is to provide a replacement smart card that overcomes the limitations of the prior art.

Another object of the present invention is to provide a replacement smart card that allows the user to use a remanufactured printer cartridge for a printer.

Another object of the present invention is to provide a replacement smart card that allows interoperation between a replacement printer cartridge and a printer.

Another object of the present invention is to provide a replacement smart card with a microcontroller and an integrated circuit that provides all of the information needed to allow the smart card to communicate with the printer model or models for which the original integrated circuit was made.

Another object of the present invention is to provide a replacement smart card with a microcontroller and an integrated circuit that provides all of the information needed to allow the smart card to communicate with the printer model or models for which the original integrated circuit was made, but the smartcard may be manufactured in any number of shapes as required to fit specific imaging machines.

Other features and advantages are inherent in the replacement smart card claimed and disclosed will become apparent to those skilled in the art from the following detailed description and its accompanying drawings.

### BRIEF DESCRIPTION OF THE DRAWINGS

FIG. 1 is an illustration of a prior art smart card.

FIG. 2 is an illustration of a front view of one embodiment of the invention.

FIG. 3 is an illustration of a front view of another embodiment of the invention.

FIG. 4 is a diagram of a data table of an original manufacturer smart card.

FIG. 5 is a diagram of a data table of a blank smart card.

FIG. 6 is a diagram of a data table of a smart card of one embodiment of the invention.

FIG. 7 is a diagram of a functional data table of a smart card of one embodiment of the invention and shows how the microcontroller provides unique lot number data.

FIG. 8 is a diagram of a prior art miniature smart card.

FIG. 9 is a diagram of a back view of one embodiment of the miniature smart card.

FIG. 10 is a diagram of a front view of one embodiment of the miniature smart card.

### DETAILED DESCRIPTION OF THE DRAWINGS

In the following detailed description of the various embodiments of the invention, numerous specific details are set forth in order to provide a thorough understanding of various embodiments of the invention. However, one or more embodiments of the invention may be practiced without these specific details. In other instances, well-known methods, procedures, and/or components have not been described in detail so as not to unnecessarily obscure aspects of embodiments of the invention.

In the following detailed description of the various embodiments of the invention, reference is made to the accompanying drawings that form a part hereof, and in which is shown by way of illustration a specific embodiment in which the invention may be practiced. It is to be understood that other embodiments may be utilized and structural changes may be made without departing from the scope of the present invention. Accordingly, the drawings and detailed description are to be regarded as illustrative in nature and not restrictive. In addition, the reference or non-reference to a particular embodiment of the invention shall not be interpreted to limit the scope of the invention.

In the following description, certain terminology is used to describe certain features of one or more embodiments of the invention. For instance “printer” refers to any image forming device that accepts the use of an ink or toner cartridge, including, but not limited to printers, copiers, facsimiles, or machines that combine printing, copying, and faxing. “Microcontroller” is any system, device, or execution unit with functionality capable of enabling the communications, compatibility, and interoperations described herein. The “microcontroller” is capable of storing information, receiving signals, including those signals received from an outside source, such as a printer, and transmitting signals. Preferably the “microcontroller” is a single integrated circuit. A “printer cartridge” is a replaceable ink or toner cartridge that is accepted into a “printer” The term “smart card” refers to a contact or contactless device that that has an integrated circuit or chip.

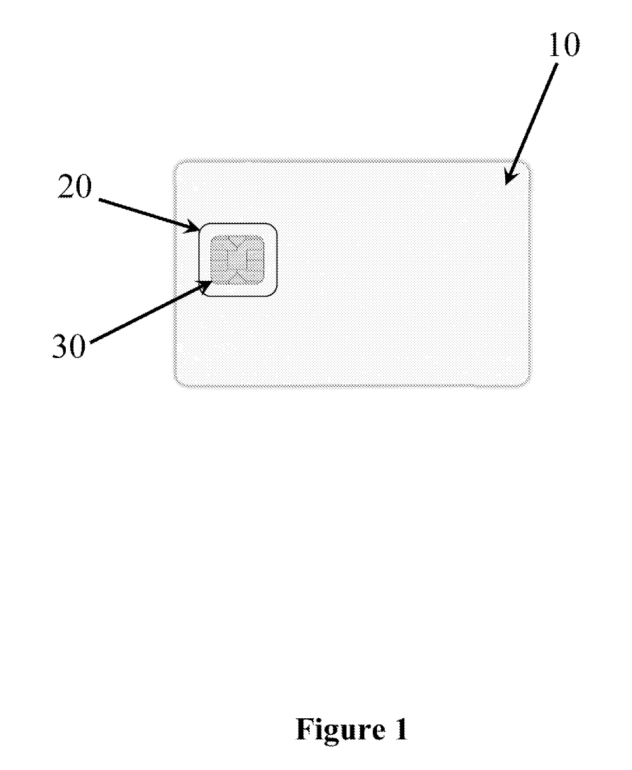

FIG. 1 is an illustration of a prior art smart card. As shown in FIG. 1, the typical prior art smart card 10 has an imbedded integrated circuit 20. FIG. 1 shows how integrated circuit 20 has contacts 30. Contacts 30 are positioned such that when the smart card 10 is inserted into a printer the contacts engage with the machine and allow the card to be communicated with by the machine. The prior art smart card shown in FIG. 1 is typically programmed to allow the printer to utilize a new printer cartridge. Once the card is used to enable operation of a printer cartridge, the printer locks the card so that it cannot be used with another printer cartridge.

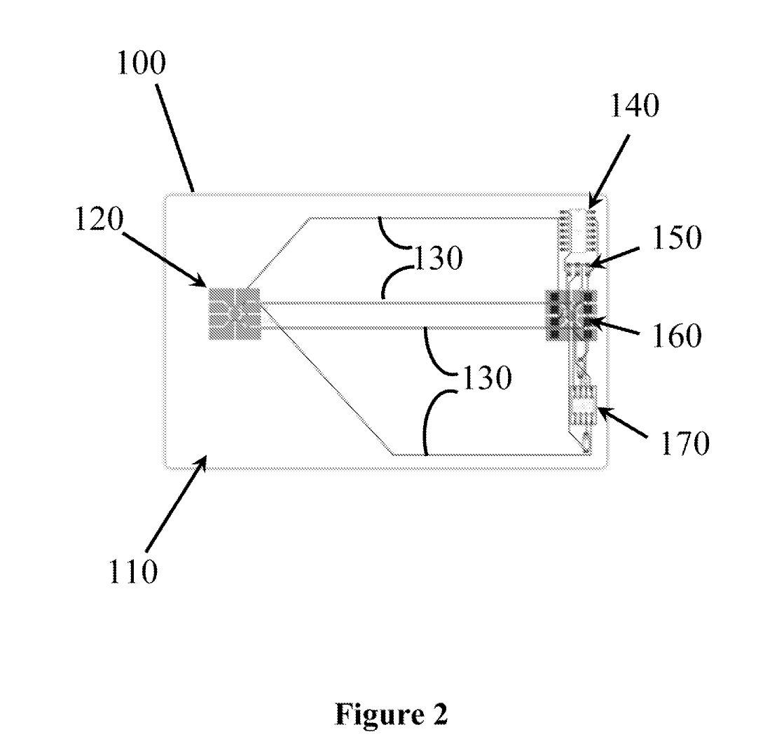

FIG. 2 is an illustration of a front view of one embodiment of the invention. As shown in FIG. 2, the smart card 100 of the present invention preferably is a printed circuit board 110 that has an integrated circuit that preferably includes: exposed contacts 120; transfer circuit 130; switch 140; supporting components 150; integrated circuit 160; and microcontroller 170. The smart card 100 is a replacement smart card that is designed to allow interoperation between a printer and a replacement printer cartridge. The smart card 100 is preferably has the same shape and thickness of a prior art smart card so that it can engage a smart card slot on the printer. As shown in FIG. 2, the exposed contacts 120 are preferably placed on the smart card 100 such that when the smart card 100 is placed into the slot, the exposed contacts 120 engage with the exposed contacts of the printer. This connection allows the printer to communicate with the smart card 100.

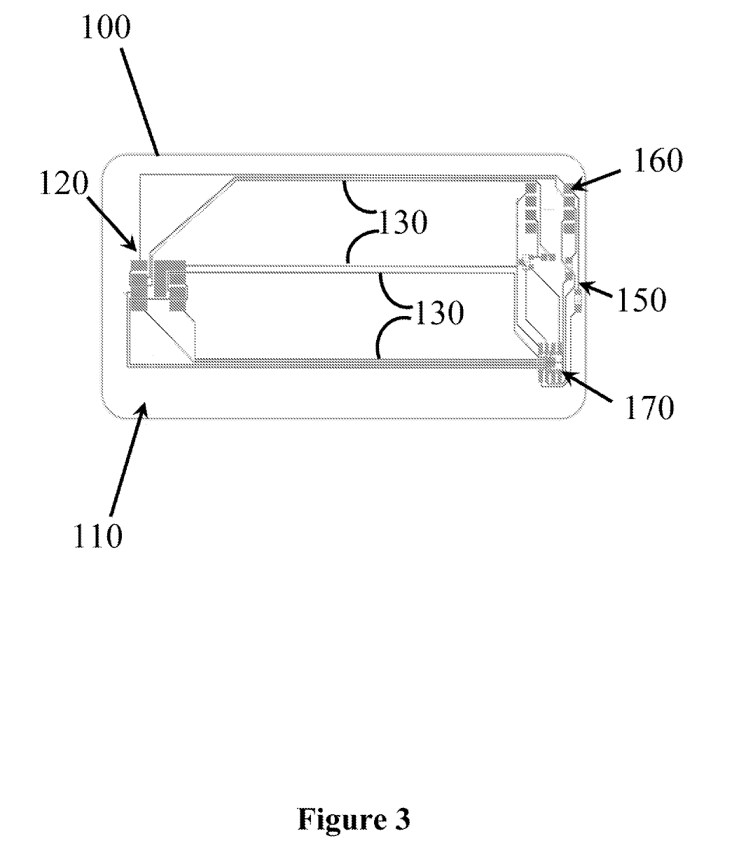

FIG. 3 is an illustration of a front view of another embodiment of the invention. As shown in FIG. 3, the smart card 100 of the present invention preferably is a printed circuit board 110 that has an integrated circuit that preferably includes: exposed contacts 120; transfer circuit 130; supporting components 150; integrated circuit 160; and microcontroller 170. The smart card 100 is a replacement smart card that is designed to allow interoperation between a printer and a replacement printer cartridge. The smart card 100 is preferably has the same shape and thickness of a prior art smart card so that it can engage a smart card slot on the printer. As shown in FIG. 3, the exposed contacts 120 are preferably placed on the smart card 100 such that when the smart card 100 is placed into the slot, the exposed contacts 120 engage with the exposed contacts of the printer. This connection allows the printer to communicate with the smart card 100.

Although the preferred embodiment of the invention includes exposed contacts, it should be understood that the smart card 100 may have a contactless engagement mechanism. When the smart card 100 is a contactless card, the smart card 100 requires only close proximity to the printer to communicate with the printer. Typically, with a contactless system, both the printer and the card have antennae and the two communicate using radio frequency over a contactless link. Moreover, it should also be understood that the smart card 100 may be a hybrid contactless and contact card, without deviating from the scope of the invention.

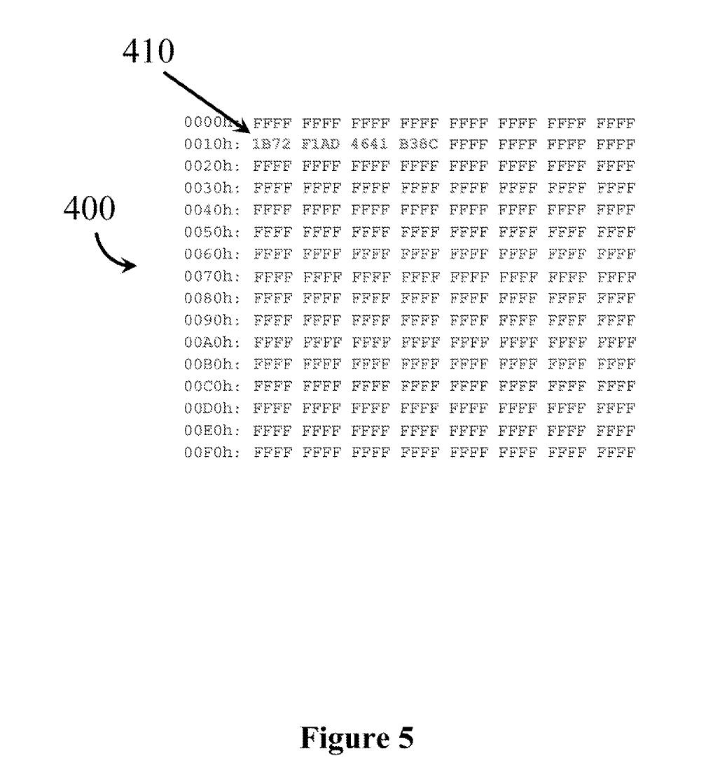

Once the smart card 100 is in communication with the printer, the communications will be transmitted through the transmission circuit 130 to the circuit that has the microcontroller 170, the integrated circuit 160, and the switch 140. The integrated circuit 160 is preferably programmed with the specific data for the respective printer with which it will be in communication. The integrated circuit 160 is preferably commercially available and, after programming, in all respects identical or substantially similar to the integrated circuit that would normally be embedded in a smart card made by the original equipment manufacturer. However, the typical commercially available integrated circuit has a locked standard lot number (as shown in FIG. 5), which is also called the unique lot number data. This locked lot number cannot be reprogrammed or overwritten. As such, the integrated circuit 160 cannot be programmed to have different unique lot number data. Therefore, when the printer requests from the smart card 100 the information stored at the locked standard lot number location, the information returned from the integrated circuit would be incorrect and the smart card would not enable interoperation between the printer and the replacement printer cartridge.

The microcontroller 170 monitors the communications from the printer into which the smart card 100 was inserted and it intercepts communications that request information stored at the locked standard lot number location. In this manner, the integrated circuit 160 is blocked from receiving and responding to this specific request. However, preferably, all other communications between the printer and the integrated circuit 160 are not blocked and the integrated circuit 160 accepts all reads and writes from the printer, just as an original equipment manufacturer integrated circuit would do.

In various embodiments of the invention, the microcontroller uses a switch 140 to block or otherwise intercept the request for the unique lot number data. However, switch 140 is not required to enable microcontroller 170 to intercept the request for the unique lot number data. Once the request for the unique lot number data has been intercepted, the microcontroller returns the appropriate unique lot number data to the printer to enable interoperation of the printer and the replacement printer cartridge. The microcontroller has been programmed with the appropriate unique lot number data that the printer will accept.

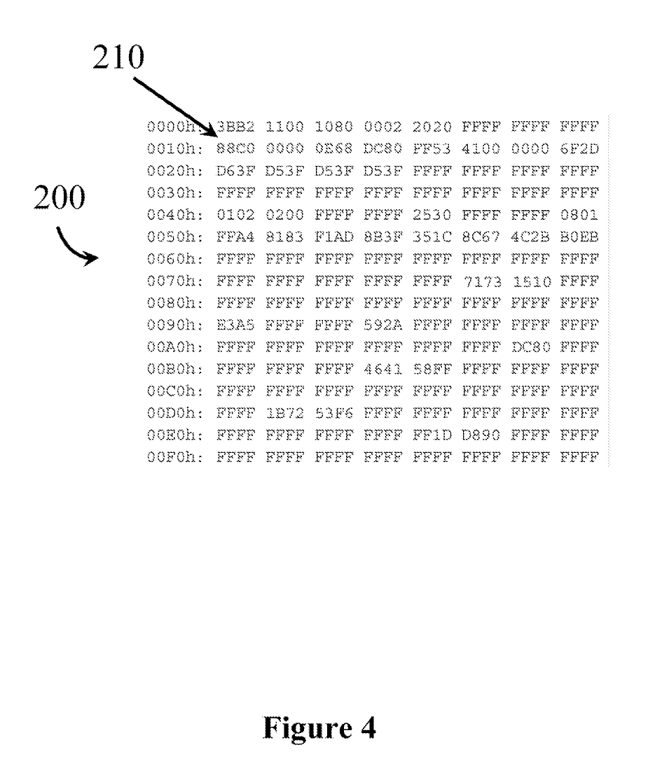

FIG. 4 is a diagram of a data table of an original manufacturer smart card. As shown in FIG. 3, the original equipment manufacturer integrated circuit data table 200 has a unique lot number 210 at a specific location. In this case, the location is “0010h”. This unique lot number 210 data is specific to the original equipment manufacturer and cannot be duplicated on another typical smart card integrated circuit. FIG. 3 shows how some of the locations of data table 200 are populated and others are blank.

FIG. 5 is a diagram of a data table of a blank smart card. As shown in FIG. 5, a commercially available blank smart card has an integrated circuit data table 400, which has a unique lot number 410 at a specific location. In this case, the location is “0010h”. Preferably, as shown in FIG. 5, the blank integrated circuit data table 400 is substantially unpopulated with data.

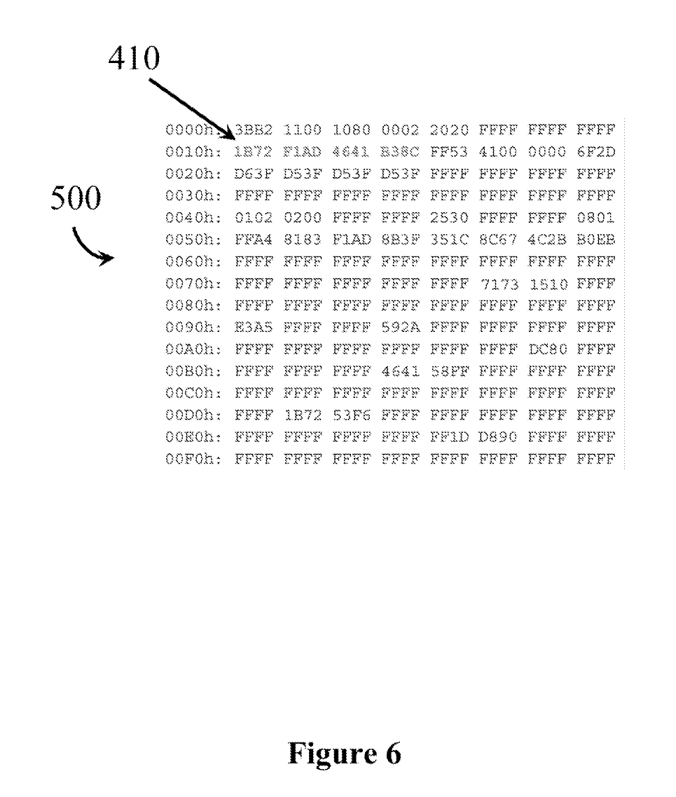

FIG. 6 is a diagram of a data table of a smart card of one embodiment of the invention. As shown in FIG. 6, the integrated circuit 160 (shown in FIG. 2) has a data table 500 that, with the exception of the unique lot number 410, is identical or substantially similar to data table 200 (as shown in FIG. 4). For example, the data in the seventh column of location “00A0h” is “DC80” in both data table 500 and data table 200 (as shown in FIG. 4). In this manner, the integrated circuit 160 is able to communicate with and interoperate with the designated printer.

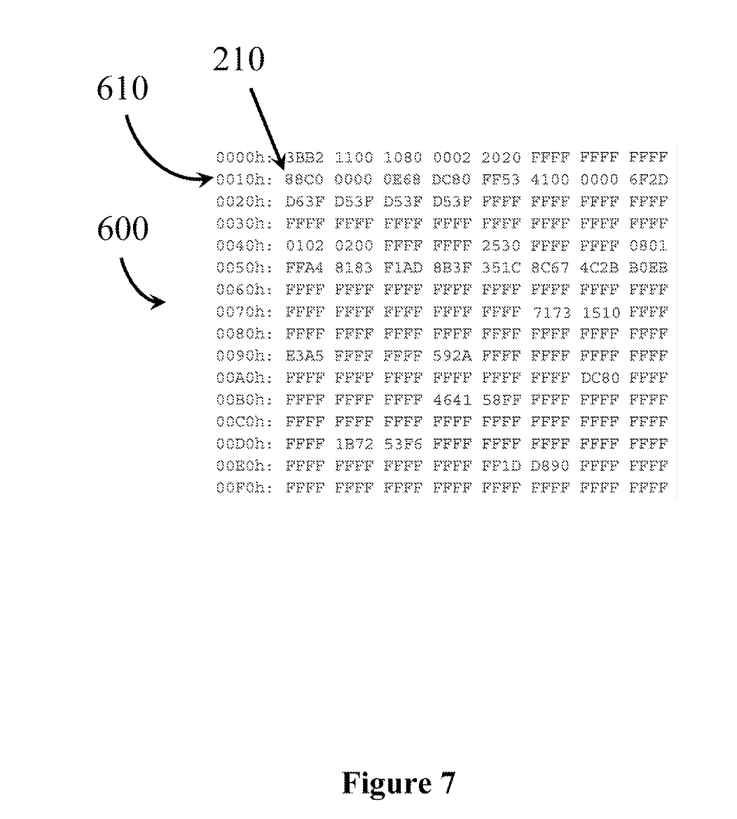

FIG. 7 is a diagram of a functional data table of a smart card of one embodiment of the invention and shows how the microcontroller provides unique lot number data. FIG. 7 shows data table 600 as it functions with the printer. Specifically, when the printer requests information from the unique lot number location 610, the microcontroller functions to provide the unique lot number data 210 to the printer. Thus, although the data table 600 of the integrated circuit of the present invention is not actually programmed with the unique lot number data 210, the printer believes it is and accepts the appropriate unique lot number as provided by the microcontroller.

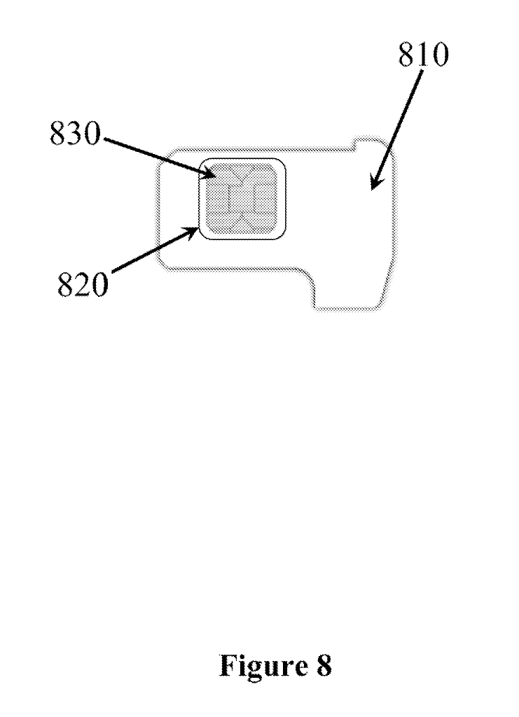

FIG. 8 is a diagram of a prior art miniature smart card. As shown in FIG. 8, the typical prior art smart card 810 has an imbedded integrated circuit 820. FIG. 8 shows how integrated circuit 820 has contacts 830. Contacts 830 are positioned such that when the miniature smart card 810 is inserted into a printer the contacts engage with the machine and allow the card to be communicated with by the machine. The prior art smart card shown in FIG. 8 is typically programmed to allow the printer to utilize a new printer cartridge. Once the card is used to enable operation of a printer cartridge, the printer locks the card so that it cannot be used with another printer cartridge. The miniature smart card is typically left in the slot on the printer for the life of the newly installed printer cartridge.

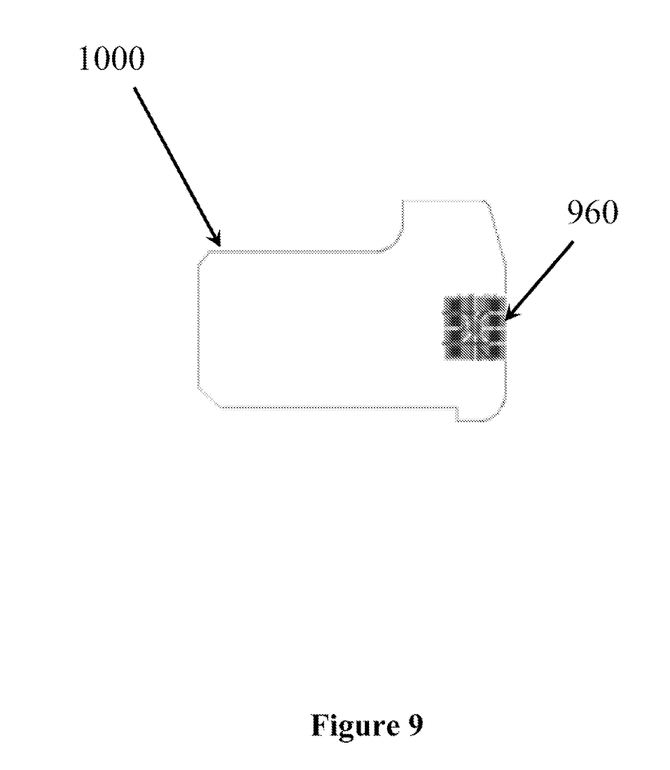

FIG. 9 is a diagram of a back view of one embodiment of the miniature smart card. FIG. 9 shows that the integrated circuit 960 is preferably on the back side of the miniature smart card 1000, due to the space constraints of the miniature smart card in this embodiment.

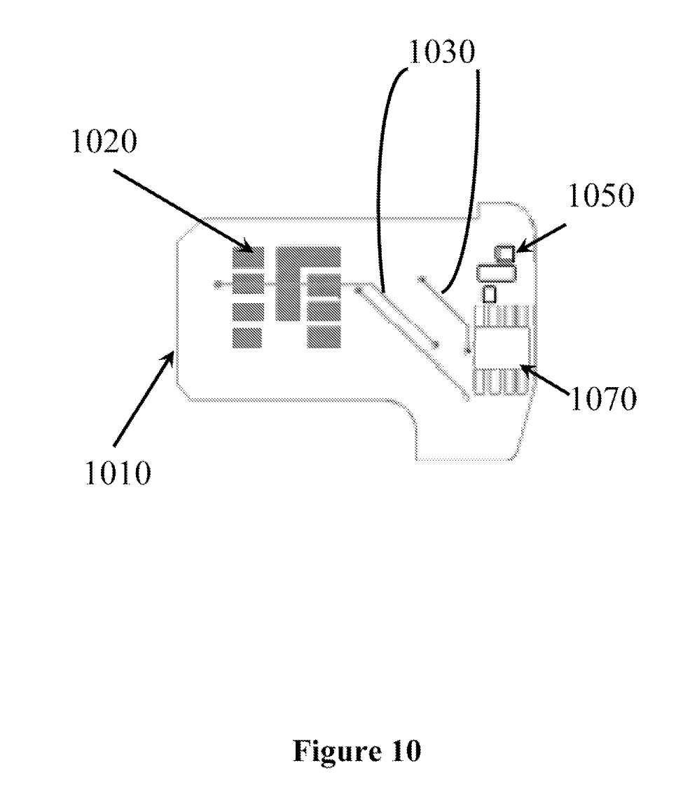

FIG. 10 is a diagram of a front view of one embodiment of the miniature smart card. As shown in FIG. 2, the miniature smart card 1000 of the present invention preferably is a printed circuit board 1010 that has an integrated circuit that preferably includes: exposed contacts 120; transfer circuit 1030; supporting components 1050; and microcontroller 1070. The miniature smart card 1000 is a replacement smart card that is designed to allow interoperation between a printer and a replacement printer cartridge. The miniature smart card 1000 is preferably has the same shape and thickness of a prior art smart card so that it can engage a smart card slot on the printer. As shown in FIG. 10, the exposed contacts 1020 are preferably placed on the miniature smart card 1000 such that when the miniature smart card 1000 is placed into the slot, the exposed contacts 1020 engage with the exposed contacts of the printer. This connection allows the printer to communicate with the miniature smart card 1000.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope of the invention. It is intended that the scope of the invention not be limited by this detailed description, but by the claims and the equivalents to the claims that are appended hereto.

We claim:

1. A replacement smart card comprising:
a smart card;
wherein said smart card is a printed circuit board that is comprised of a circuit;
wherein said circuit is comprised of an integrated circuit and a microcontroller;
wherein said smart card engages with a printer and said printer sends and receives one or more communications from said smart card;
wherein said circuit monitors one or more communications sent from said printer to said smart card;
wherein said printer sends a request for a unique lot number data to said smart card;
wherein said circuit senses when said printer sends said request for said unique lot number data and directs said request to said microcontroller;
wherein said microcontroller is programmed with said unique lot number data and returns said unique lot number data to said printer, which allows said printer to utilize a replacement printer cartridge.

2. The replacement smart card of claim 1, wherein said microcontroller evaluates said one or more communications from said printer;
wherein said microcontroller blocks said request for said unique lot number data from said printer from reaching said integrated circuit; and
wherein said microcontroller returns said unique lot number from a memory of said microcontroller to said printer, which allows said printer to utilize said replacement printer cartridge.

3. The replacement smart card of claim 1, wherein said smart card further comprises one or more contacts;
wherein said smart card is inserted into a slot of said printer;
wherein said one or more contacts engage with one or more printer contacts and allows said printer to send and receive one or more communications with said smart card.

4. The replacement smart card of claim 1, wherein said circuit further comprises a switch;
wherein said switch allows either said integrated circuit or said microcontroller to be in communication with said printer.

5. The replacement smart card of claim 1, wherein said circuit further comprises one or more supporting components.

6. The replacement smart card of claim 1, wherein said integrated circuit is programmed with a set of data.

7. The replacement smart card of claim 6, wherein said set of data is specific to a particular type of printer and is substantially similar to an original equipment manufacturer set of data except for said unique lot number data.

8. The replacement smart card of claim 7, wherein said smart card functions just like an original equipment manufacturer smart card and accepts one or more communications from said printer and answers said one or more communications; and
wherein said request for said unique lot number data is answered by said microcontroller instead of said integrated circuit.

9. The replacement smart card of claim 2, wherein said smart card further comprises one or more contacts;
wherein said smart card is inserted into a slot of said printer;
wherein said one or more contacts engage with one or more printer contacts and allows said printer to send and receive one or more communications with said smart card.

10. The replacement smart card of claim 9, wherein said circuit further comprises a switch;
wherein said switch allows either said integrated circuit or said microcontroller to be in communication with said printer.

11. The replacement smart card of claim 10, wherein said integrated circuit is programmed with a set of data.

12. The replacement smart card of claim 11, wherein said set of data is specific to a particular type of printer and is substantially similar to an original equipment manufacturer set of data except for said unique lot number data.

13. The replacement smart card of claim 12, wherein said smart card functions just like an original equipment manufacturer smart card and accepts one or more communications from said printer and answers said one or more communications; and
wherein said request for said unique lot number data is answered by said microcontroller instead of said integrated circuit.

14. The replacement smart card of claim 13, wherein said circuit further comprises one or more supporting components.

15. A replacement smart card comprising:
a smart card;
wherein said smart card is a printed circuit board that is comprised of a circuit;
wherein said circuit is comprised of an integrated circuit, a microcontroller, a transfer printed circuit, one or more contacts, and one or more supporting components;
wherein said smart card is inserted into a slot of a printer;
wherein said one or more contacts engage with one or more printer contacts and allows said printer to send and receive one or more communications with said smart card;
wherein said microcontroller evaluates said one or more communications from said printer;
wherein said printer requests from said smart card a unique lot number data;
wherein said microcontroller blocks said request for said unique lot number data from said printer from reaching said integrated circuit;
wherein said microcontroller is programmed with said unique lot number data and returns said unique lot number data to said printer when requested, which allows said printer to utilize a replacement printer cartridge;
wherein said integrated circuit is programmed with a set of data;
wherein said set of data is specific to a particular type of printer and is substantially similar to an original equipment manufacturer set of data except for said unique lot number data;
wherein said smart card functions just like an original equipment manufacturer smart card and accepts one or more communications from said printer and answers said one or more communications; and
wherein said request for said unique lot number data is answered by said microcontroller instead of said integrated circuit.

16. The replacement smart card of claim 15, further comprising:
a switch;
wherein said microcontroller activates said switch and wherein said switch blocks said request for said unique lot number data from said printer from reaching said integrated circuit.

17. A method of enabling interoperation between a replacement printer cartridge and a printer comprising the steps of:
providing a printer;
providing a replacement printer cartridge;
wherein said printer has a cavity that accepts said replacement printer cartridge;
inserting said replacement printer cartridge into said printer cavity;
providing a replacement smart card;
wherein said printer has a slot for said replacement smart card;
wherein said replacement smart card allows for utilization of said replacement printer cartridge by said printer;
wherein said replacement smart card is a printed circuit board that is comprised of a circuit;
wherein said circuit is comprised of an integrated circuit, a microcontroller, and one or more contacts;
inserting said replacement smart card into said slot;
wherein said one or more contacts engage with one or more printer contacts;
sending and receiving communications by said printer with said replacement smart card;
evaluating by said microcontroller said one or more communications from said printer;
requesting by said printer a unique lot number data from said replacement smart card;
wherein said microcontroller is programmed with said unique lot number data;
returning said unique lot number data to said printer by said microcontroller, which allows said printer to utilize said replacement printer cartridge.

18. The method of enabling interoperation between a replacement printer cartridge and a printer of claim 16, wherein said circuit further comprises a switch;
activating said switch by said microcontroller;
blocking by said switch said request for said unique lot number data from said printer from reaching said integrated circuit.

19. The method of enabling interoperation between a replacement printer cartridge and a printer of claim 17, further comprising the steps of:
programming said integrated circuit with a set of data;
wherein said set of data is specific to a particular type of printer and is substantially similar to an original equipment manufacturer set of data except for said unique lot number data;
wherein said replacement smart card functions just like an original equipment manufacturer replacement smart card and accepts and responds to said one or more communications from said printer except for said request for said unique lot number data.
